(19) United States
(12) Patent Application Publication
(10) Pub. No.: US 2006/0147770 A1
(43) Pub. Date: Jul. 6, 2006

(54) Reduction of voltage loss caused by voltage cycling by use of a rechargeable electric storage device

(76) Inventor: Bernd Krause, Liederbach (DE)

Correspondence Address: CARY W. BROOKS;General Motors Corporation, Legal Staff, Mail Code 482-C23-B21, P.O. Box 300, Detroit, MI, 48265-4717, US

(21) Appl. No.: 11/028,887

(22) Filed: Jan. 4, 2005

(51) Int. Cl. H01M 8/04

(52) U.S. Cl. 429/23; 429/13

(57) ABSTRACT

A fuel cell system that employs a fuel cell stack and a supplemental power source, such as a battery or an ultra-capacitor. The power source provides supplemental power in addition to the output power of a fuel cell stack for high load demands. The fuel cell system includes a power management controller that controls the power output from the supplemental power source and the fuel cell stack as the demand on the fuel cell stack changes. During low load demands, where the voltage across the fuel cell stack may increase above a potential that could cause oxidation of platinum catalyst particles within the fuel cells in the stack, the power management controller causes the fuel cell stack to charge the power source so as to decrease the voltage output on the stack.

### BACKGROUND OF THE INVENTION

1. Field of the Invention

This invention relates generally to a fuel cell system that employs a supplemental power source and, more particularly, to a fuel cell system that employs a supplemental power source, where the fuel cell system uses a power control strategy where the battery draws power from the fuel cell stack during low load request from the fuel cell system to prevent or reduce the times that the voltage potential of the stack goes over a predetermined voltage that causes voltage cycling.

2. Discussion of the Related Art

Hydrogen is a very attractive fuel because it is clean and can be used to efficiently produce electricity in a fuel cell. The automotive industry expends significant resources in the development of hydrogen fuel cells as a source of power for vehicles. Such vehicles would be more efficient and generate fewer emissions than today's vehicles employing internal combustion engines.

A hydrogen fuel cell is an electrochemical device that includes an anode and a cathode with an electrolyte therebetween. The anode receives hydrogen gas and the cathode receives oxygen or air. The hydrogen gas is dissociated in the anode to generate free hydrogen protons and electrons. The hydrogen protons pass through the electrolyte to the cathode. The hydrogen protons react with the oxygen and the electrons in the cathode to generate water. The electrons from the anode cannot pass through the electrolyte, and thus are directed through a load to perform work before being sent to the cathode. The work acts to operate the vehicle.

Proton exchange membrane fuel cells (PEMFC) are a popular fuel cell for vehicles. The PEMFC generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation. These conditions include proper water management and humidification, and control of catalyst poisoning constituents, such as carbon monoxide (CO).

Several fuel cells are typically combined in a fuel cell stack to generate the desired power. The fuel cell stack receives a cathode input gas, typically a flow of air forced through the stack by a compressor. Not all of the oxygen is consumed by the stack and some of the air is output as a cathode exhaust gas that may include water as a stack by-product. The fuel cell stack also receives an anode hydrogen input gas that flows into the anode side of the stack.

Certain fuel cell vehicles are hybrid vehicles that employ a supplemental power source, such as a DC battery or a super-capacitor, in addition to the fuel cell stack. The fuel cell stack provides power to a traction motor through a DC voltage bus line for vehicle operation. The battery provides supplemental power to the voltage bus line during those times when additional power is needed beyond what the stack can provide, such as during acceleration. For example, the fuel cell stack may provide 70 kW of power. However, vehicle acceleration may require 100 kW of power. The generator power available from the traction motor during regenerative braking is typically used to recharge the battery.

It has been discovered that a typical fuel cell stack will have a voltage loss or degradation over the lifetime of the stack. It is believed that the fuel cell stack degradation is, among others, a result of voltage cycling of the stack. The voltage cycling occurs when the platinum catalyst particles used to enhance the electro-chemical reaction transition between an oxidized state and a non-oxidized state, which causes dissolution of the particles. If the voltage of the fuel cell stack is less than about 0.8 volts, the platinum particles are not oxidized and remain a metal. When the voltage of the fuel cell stack goes above about 0.8 volts, the platinum crystals begin to oxidize. A low load on the stack may cause the voltage output of the fuel cell stack to go above 0.8 volts. The 0.8 volts corresponds to a current density of 0.2 A/cm², depending on the power density of the MEA, where a current density above this value does not change the platinum oxidation state. The oxidation voltage threshold may be different for different stacks and different catalysts.

When the platinum particles transition between a metal state and an oxidized state, oxidized ions in the platinum are able to move from the surface of the MEA towards the membrane and probably into the membrane. When the particles convert back to the metal state, they are not in a position to assist in the electrochemical reaction, reducing the active catalyst surface and resulting in the voltage degradation of the stack.

FIG. 1 is a graph with number of voltage cycles on the horizontal axis and normalized platinum surface area on the vertical axis showing that as the number of voltage cycles between oxidation and metal state increases, the platinum surface area decreases causing the voltage degradation of the stack. The degradation will be different for different types of catalysts, including catalysts of different particle sizes, concentrations and compositions.

### SUMMARY OF THE INVENTION

In accordance with the teachings of the present invention, a fuel cell system is disclosed that employs a fuel cell stack and a supplemental power source, such as a battery, an ultra-capacitor or any other rechargeable electric energy source. The supplemental power source provides supplemental power in addition to the output power of the fuel cell stack for high load demands, such as during vehicle acceleration. The fuel cell system includes a power management controller that controls the power output from the supplemental power source and the fuel cell stack as the demand on the fuel cell stack changes. During low load conditions, where the voltage of the fuel cell stack may increase above a potential that could cause oxidation of platinum catalyst particles within the fuel cells in the stack, the power management controller causes the fuel cell stack to charge the power source so as to increase the load on the stack and decrease the voltage of the stack in order to prevent voltage cycling, and therefore voltage degradation.

In one embodiment, the power management controller provides a control scheme where the power source may be used to provide power for the traction system of the vehicle at the beginning of the power demand, so that the state of charge of the power source is low enough to be used to draw power from the fuel cell stack during low load conditions thereafter.

Additional advantages and features of the present invention will become apparent from the following description and appended claims, taken in conjunction with the accompanying drawings.

### BRIEF DESCRIPTION OF THE DRAWINGS

FIG. 1 is a graph with number of voltage cycles on the horizontal axis and platinum surface area on the vertical axis showing the relationship between voltage cycling and reduction of the platinum surface area in a fuel cell; and

FIG. 2 is a block diagram of a fuel cell system for a vehicle, where the system employs a supplemental power source that is charged by a fuel cell stack during low load operation to prevent or reduce voltage cycling, according to an embodiment of the present invention.

### DETAILED DESCRIPTION OF THE EMBODIMENTS

The following discussion of the embodiments of the invention directed to a method for controlling a fuel cell system employing a supplemental power source is merely exemplary in nature, and is in no way intended to limit the invention or its applications or uses. For example, the discussion below for the fuel cell system has particular application for providing power in a fuel cell hybrid vehicle. However, the fuel cell system of the invention may have other uses and applications.

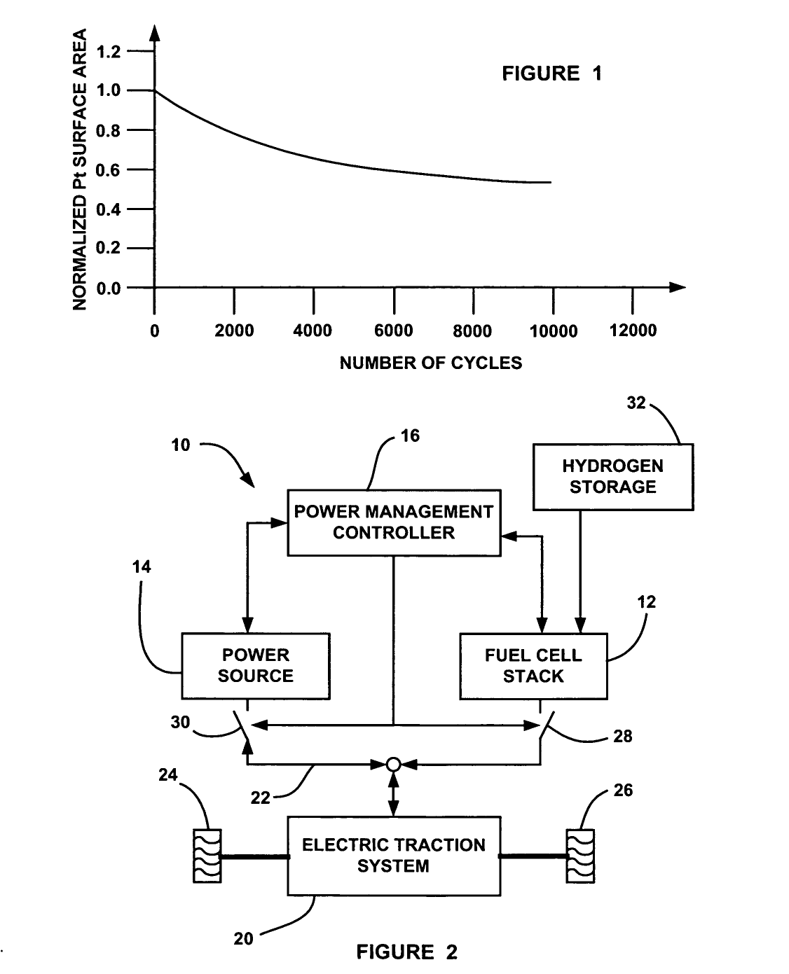

FIG. 1 is a block diagram of a fuel cell system 10 for a vehicle. The vehicle is a fuel cell hybrid vehicle in that it includes both a fuel cell stack 12 and a supplemental power source 14. The supplemental power source 14 can be any suitable source, such as a battery, ultra-capacitor, etc., that is rechargeable and provides additional power to drive the vehicle when the load on the fuel cell stack 12 is beyond its power capabilities, such as during acceleration. The fuel cell system 10 includes a power management controller 16 that receives state of charge information from the power source 14 and output voltages from each fuel cell in the fuel cell stack 12. The power management controller 16 also receives load demands from the vehicle systems, so as to provide the proper power output from the power source 14 and the fuel cell stack 12 to meet the demands.

The supplemental power source 14 and the fuel cell stack 12 provide output power to a vehicle electric traction system 20 on a voltage bus 22. The traction system 20 provides rotation to vehicle wheels 24 and 26. The electric traction system 20 can be any suitable electric traction system for a vehicle of this type, and would probably include an AC synchronous motor and a power inverter, as would be well understood to those skilled in the art. The power management controller 16 also controls a switch 28 between the fuel cell stack 12 and the voltage bus 22 and a switch 30 between the power source 14 and the voltage bus 22, so that the fuel cell stack 12 and the power source 14 can be disconnected from the voltage bus 22. Therefore, if the electric traction system 20 is being used to recharge the power source 14 during regenerative braking, the fuel cell stack 12 can be disconnected from the bus 22. Likewise, if the power source 14 is fully charged, the power source 14 can be disconnected from the bus 22 during regenerative braking. Providing power to the traction system 20 is just one example of an application for the fuel cell system 10. The fuel cell system 10 can provide power to any suitable device.

The fuel cell system 10 also includes a hydrogen storage tank 32 that provides hydrogen for the fuel cell stack 12 as the anode input, as is well understood in the art. The hydrogen storage tank 32 can be a cryogenic tank storing liquid hydrogen or a compressed gas tank storing compressed hydrogen gas. Alternately, the hydrogen storage tank 32 can be replaced with a reformer that produces hydrogen.

According to the invention, the power management controller 16 controls the fuel cell stack 12 and the supplemental power source 14 in combination to reduce or eliminate stack voltage cycling. Particularly, the controller 16 attempts to prevent the output voltage of the fuel cell stack 12 from going above a voltage potential threshold where the platinum catalyst particles in the MEAs of the several fuel cells in the stack 12 oxidize. In one embodiment, this voltage potential above which the particles begin to oxidize is about 0.8 volts, which corresponds to a cell current density of about 0.2 A/cm². If the demand on the fuel cell stack 12 is low enough to cause the voltage potential to go above the oxidation threshold, the power management controller 16 causes the fuel cell stack 12 to be electrically coupled to the supplemental power source 14 to recharge the power source 14 as a load.

Of course, the fuel cell stack 12 cannot charge the supplemental power source 14 if it is already fully charged. Therefore, the power management controller 16 employs a control scheme where the state of charge of the power source 14 is maintained below a full state of charge. When the power source 14 is at or near a full state of charge, the electrical output of the power source 14 is used to drive the traction system 20. Once the power source 14 has been discharged to a certain state of charge, the power management controller 16 will then allow the fuel cell stack 12 to charge the power source 14 during those times when the demand would cause the output voltage of the fuel cell stack 12 to go above the oxidation threshold. For example, when the vehicle is initially accelerated, the power source 14 can be used to provide power to the traction system 20. When the vehicle is stopped, such as at a stoplight where the stack load would be low, an additional load on the stack 12 can be provided to charge the battery 16 to maintain the voltage on the stack below the oxidation threshold.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A fuel cell system comprising:
a fuel cell stack including a stack of fuel cells;
a supplemental power source electrically coupled to the fuel cell stack; and
a power controller, said controller controlling the power output of the fuel cell stack and the supplemental power source by using the power source as a load on the stack to maintain a voltage on the fuel cell stack below a predetermined oxidation threshold.

2. The fuel cell system according to claim 1 wherein the oxidation threshold is the threshold where platinum catalyst particles in the fuel cells begin to oxidize.

3. The fuel cell system according to claim 1 wherein the oxidation threshold is about 0.8 volts.

4. The fuel cell system according to claim 1 wherein the controller uses a control scheme that reduces or eliminates voltage cycling of the stack.

5. The fuel cell system according to claim 1 wherein the power source is selected from the group consisting of batteries and capacitors.

6. The fuel cell system according to claim 1 wherein the fuel cell stack and the supplemental power source provide output power to drive an electric traction system on a vehicle.

7. A fuel cell system comprising:
a fuel cell stack including a stack of fuel cells;
a supplemental power source; and
a controller for controlling the power output of the fuel cell stack and the supplemental power source, said controller electrically coupling the fuel cell stack to the power source at low load demands so as to reduce or prevent voltage cycling of the fuel cell stack.

8. The fuel cell system according to claim 7 wherein the voltage cycling is defined as the voltage where platinum catalyst particles in the fuel cells begin to oxidize.

9. The fuel cell system according to claim 8 wherein the oxidation voltage is about 0.8 volts.

10. The fuel cell system according to claim 7 wherein the power source is selected from the group consisting of batteries and capacitors.

11. The fuel cell system according to claim 7 wherein the fuel cell stack and the supplemental power source provide output power to drive an electric traction system on a vehicle.

12. A method for controlling the power output of a fuel cell system, said method comprising:
providing output power from a fuel cell stack including a stack of fuel cells;
providing output power from a supplemental power source; and
controlling the power output of the fuel cell stack and the supplemental power source so as to maintain a voltage on the fuel cell stack below a predetermined oxidation threshold.

13. The method according to claim 12 wherein the oxidation threshold is the threshold where platinum catalyst particles in the fuel cells begin to oxidize.

14. The method according to claim 12 wherein the oxidation threshold is about 0.8 volts.

15. The method according to claim 12 wherein controlling the power output of the fuel cell stack and the supplemental power source includes reducing or eliminating voltage cycling of the stack.

16. The method according to claim 12 wherein providing output power from a supplemental power source includes providing output power from a supplemental power source selected from the group consisting of batteries and capacitors.

17. The method according to claim 12 providing output power from a fuel cell stack and a supplemental power source includes providing output power to drive an electric traction system on a vehicle.
